(19) United States
(12) Patent Application Publication
(10) Pub. No.: US 2021/0303963 A1
(43) Pub. Date: Sep. 30, 2021

(54) METHOD OF DETERMINING A RESCUE PLAN AND APPARATUS, SERVER AND STORAGE MEDIUM

(71) Applicant: SOUTH UNIVERSITY OF SCIENCE AND TECHNOLOGY OF CHINA, Shenzhen (CN)

(72) Inventors: Xuan Song, Shenzhen (CN); Haoran Zhang, Shenzhen (CN); Liqiao Huang, Shenzhen (CN); Ning Xu, Shanzhen (CN); Zipei Fan, Shenzhen (CN); Ryosuke Shibasaki, Shenzhen (CN)

(21) Appl. No.: 17/217,301

(22) Filed: Mar. 30, 2021

(30) Foreign Application Priority Data
Mar. 30, 2020 (CN) 202010235312.6

(51) Int. Cl. G06N 3/00; G06Q 50/26; G06Q 10/04; G06Q 50/00

(52) U.S. Cl. CPC G06N 3/006; G06Q 50/01; G06Q 10/047; G06Q 50/265

(57) ABSTRACT

Provided are a method and apparatus for determining a rescue plan, a server, and a storage medium. The method includes obtaining target locations of one or more rescue targets and hospital locations of one or more hospitals, determining rescue-center locations of one or more rescue centers based on the target locations and the hospital locations, and determining a rescue plan for rescuing the one or more rescue targets based on the target locations, the hospital locations, and the rescue-center locations. This method achieves the effect of automatically generating a rescue plan in response to a disaster event.

### CROSS-REFERENCE TO RELATED APPLICATION

This application claims priority to China patent application No. 202010235312.6 filed on Mar. 30, 2020, disclosure of which is hereby incorporated herein by reference in its entirety.

### TECHNICAL FIELD

Embodiments of the present disclosure relate to the technical field of emergency rescue, and more particularly relate a method and apparatus for determining a rescue plan, a server, and a storage medium.

### BACKGROUND

In the past few decades, countries around the world have experienced natural disasters and other disasters with significantly increased frequencies, intensities and impacts.

Currently, in a disaster event, the number and locations of persons to be rescued need to be manually counted, and then a rescue plan is made based on the number and locations of the persons to be rescued.

However, every minute counts in the face of a disaster event, so making the rescue plan by manually counting the number and locations of the persons to be rescued may miss the best time for rescue.

### SUMMARY

Embodiments of the present disclosure provide a method and apparatus for determining a rescue plan, a server, and a storage medium to automatically generate a rescue plan in a disaster event.

According to a first aspect, an embodiment of the present disclosure provides a method of determining a rescue plan. The method includes the following operations:

obtaining target locations of one or more rescue targets and hospital locations of one or more hospitals;

determining rescue-center locations of one or more rescue centers based on the target locations and the hospital locations; and

determining a rescue plan for rescuing the one or more rescue targets based on the target locations, the hospital locations, and the rescue-center locations.

Optionally, the step of obtaining the target locations of the one or more rescue targets includes the following operations:

obtaining social media information; and

extracting the target locations of the one or more rescue targets from the social media information.

Optionally, the step of determining the rescue-center locations of the one or more rescue centers based on based on the target locations and the hospital locations includes the following operations:

performing computation on the target locations and the hospital locations using a PSO (Particle swarm optimization) algorithm to determine the rescue-center locations of the one or more rescue centers.

Optionally, the PSO algorithm may include a global particle swarm optimization (GPSO) algorithm, a local particle swarm optimization (LPSO) algorithm, a multi-swarm collaborative particle swarm optimization (MCPSO) algorithm or a selective information particle swarm optimization (SIPSO) algorithm.

Optionally, each target location is allocated one hospital or one rescue-center location. When each of the target locations is allocated one rescue-center location, and each of the rescue-center locations is matched with one hospital, then the operation of determining the rescue plan for rescuing the one or more rescue targets based on the target locations, the hospital locations, and the rescue-center locations may include the following operations:

determining a rescue sub-path corresponding to each of the target locations;

determining a plurality of rescue paths based on the rescue sub-path corresponding to each of the target locations, wherein the plurality of rescue paths are configured for rescuing all of the one or more rescue targets;

determining a total rescue time required for each of the plurality of rescue paths;

taking the shortest time among total rescue times as a target total time; and

using the rescue path corresponding to the target total time as the rescue plan for rescuing the one or more rescue targets.

Optionally, the step of determining the total rescue time required for each rescue path may include the following operations:

determining rescue sub-times required for rescue sub-paths corresponding to each of the plurality of rescue paths; and

superimposing the rescue sub-times to obtain the total rescue time.

Optionally, the step of extracting the target locations of the one or more rescue targets from the social media information may include the following operations:

extracting key information in each piece of the social media information, the key information comprising a keyword or keyphrase;

determining whether a target corresponding to the social media information is a rescue target; and

in response to determining that the corresponding target of the social media information is a rescue target, extracting a target location carried in target social media information, to obtain the target locations of the one or more rescue targets, wherein the target social media information is the social media information corresponding to the rescue target.

According to a second aspect, an embodiment of the present disclosure provides an apparatus for determining a rescue plan. The apparatus includes a location acquisition module, a rescue-center location determination module and a rescue-plan determination module.

The location acquisition module is configured to obtain target locations of one or more rescue targets and hospital locations of one or more hospitals.

The rescue-center location determination module is configured to determine rescue-center locations of one or more rescue centers based on based on the target locations and the hospital locations.

The rescue-plan determination module is configured to determine a rescue plan for rescuing the one or more rescue targets based on based on the target locations, the hospital locations and the rescue-center locations.

According to a third aspect, an embodiment of the present disclosure provides a server.

The server includes one or more processors.

The server further includes a storage device. The storage device is configured to store one or more programs.

When the one or more programs are executed by the one or more processors, the one or more processors are caused to perform the method of determining a rescue plan of any embodiment of the present disclosure.

According to a fourth aspect, an embodiment of the present disclosure provides a computer-readable storage medium. When a processor executes the computer program, the method of determining a rescue plan of any embodiment of the present disclosure is performed.

According to the embodiments of the present disclosure, target locations of one or more rescue targets and hospital locations of one or more hospitals are obtained, rescue-center locations of one or more rescue centers are determined based on the target locations and the hospital locations, and a rescue plan for rescuing the one or more rescue targets is determined based on the target locations, the hospital locations and the rescue-center locations. This solves the problem that the method of making the rescue plan by manually counting the number and locations of persons to be rescued will miss the best time for rescue, thus achieving the effect of automatically generating a rescue plan in response to a disaster event.

### BRIEF DESCRIPTION OF DRAWINGS

FIG. 1 is a flowchart of a method of determining a rescue plan according to Embodiment one of the present disclosure.

FIG. 2 is a schematic diagram illustrating the distribution of target locations, rescue-center locations and hospital locations according to Embodiment one of the present disclosure.

FIG. 3 is a flowchart of a method of determining a rescue plan according to Embodiment two of the present disclosure.

FIG. 4 is a schematic diagram illustrating a rescue-plan determination apparatus according to Embodiment three of the present disclosure.

FIG. 5 is a schematic diagram illustrating a server according to Embodiment four of the present disclosure.

### DETAILED DESCRIPTION

Hereinafter the present disclosure is further described in detail in conjunction with the drawings and embodiments. It is to be understood that the specific embodiments set forth below are intended to illustrate and not to limit the present disclosure. Additionally, it is further to be noted that for ease of description, only part, not all, of the structures related to the present disclosure are illustrated in the drawings.

Before the exemplary embodiments are discussed in more detail, it is to be noted that parts of the exemplary embodiments are described as processes or methods depicted in flowcharts. Although the flowcharts describe the steps as sequentially processed, many of the steps may be implemented concurrently, coincidently or simultaneously. Additionally, the sequence of the steps may be rearranged. A process may be terminated when operations of the process are completed, but may further have additional steps not included in the drawings. The process may correspond to a method, a function, a procedure, a subroutine, a subprogram or the like.

Furthermore, the terms “first”, “second” and the like may be used herein to describe various directions, acts, steps, elements or the like, but these directions, acts, steps or elements are not limited by these terms. These terms are only used to distinguish one direction, action, step or element from another direction, action, step or element. For example, without departing from the scope of the present application, first information may be referred to as second information, and similarly, the second information may be referred to as the first information. The first information and the second information are both information, but not the same information. Terms like “first”, “second” are not to be construed as indicating or implying relative importance or implicitly indicating the number of technical features as indicated. Thus, a feature defined as a “first” feature or a “second” feature may explicitly or implicitly include one or more features. In the description of the present disclosure, the term “multiple” is defined as at least two, for example, two, three or the like, unless otherwise specified and defined.

### Embodiment One

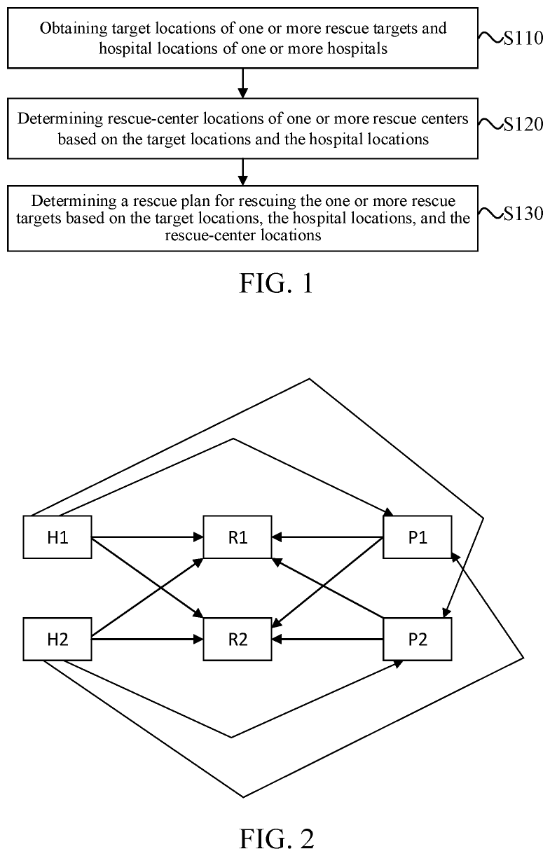

FIG. 1 is a flowchart of a method of determining a rescue plan according to Embodiment one of the present disclosure. The method may be applied in a scenario of making a rescue plan for a rescue target in a disaster event. The method may be executed by an apparatus for determining a rescue plan. The apparatus may be implemented in software and/or hardware, and may be integrated in a server.

As shown in FIG. 1, the method of determining a rescue plan according to Embodiment one of the present disclosure includes the steps described below.

In S110, target locations of one or more rescue targets are obtained, and hospital locations of one or more hospitals are obtained.

A rescue target refers to a target needing rescue. Optionally, the rescue target includes, but is not limited to, a person to be rescued, an animal to be rescued, or the like, which is not limited here. The target locations refer to locations of the one or more rescue targets. Specifically, each rescue target corresponds to a target location. A hospital location refers to the location of a hospital. Optionally, the hospital location of the hospital may be extracted from a map or a database storing hospital locations. In this embodiment, the target locations and the hospital locations may be each identified in terms of latitude and longitude.

In S120, rescue-center locations of one or more rescue centers are determined based on the target locations and the hospital locations.

A rescue-center location refers to the location of a rescue center for rescuing the rescue target. It is to be noted that there may be an established rescue center at the rescue-center location, or may be no rescue center at the rescue-center location. In this step, the rescue-center location represents a piece of location information and does not represent whether there is the rescue center at the rescue-center location. The rescue-center location may be regarded as a hub connecting the hospital and a target location.

In an optional embodiment, the step of determining the one or more rescue-center locations based on the target locations and the hospital locations includes the step described below.

Computation is performed on the target locations and the hospital locations through a PSO algorithm to determine the rescue-center locations of the one or more rescue centers.

In this embodiment, the PSO algorithm is a widely used natural-inspired optimization algorithm based on the population, and has good global accuracy. The PSO algorithm was originally designed to simulate social behavior to represent foraging behavior in bird flocks or fish schools. Each member of the population is regarded as a particle and represents a potential solution. Each particle has a fitness value. The fitness value depends on a target function. Relatively speaking, the location of food (that is, the target of the foraging behavior) represents a global optimal solution. Each particle searches for the global optimal solution in a solution space. During the search process, each particle has an optimal (individual optimal) location, and each particle may obtain a (population optimal) location where the particle is closest to the optimal solution in the population. To find the optimal solution, each particle learns the individual optimal location and the population optimal location to update the location of each particle, and finally approaches the optimal solution. This is reflected in the convergence of the search process. Optionally, the PSO algorithm includes, but is not limited to, a GPSO algorithm, an LPSO algorithm, an MCPSO algorithm or an SIPSO algorithm. Times for determining the location of the rescue center through different PSO algorithms satisfy the following relationship: the GPSO algorithm>the MCPSO algorithm>the LPSO algorithm>the SIPSO algorithm. The SIPOS algorithm has the shortest time for determining the location of the rescue center. However, the GPSO algorithm shows relatively robust convergence in different tests.

In S130, a rescue plan for rescuing the one or more rescue targets is determined based on the target locations, the hospital locations and the rescue-center locations.

The rescue plan refers to a plan for rescuing rescue targets. Optionally, the rescue plan includes, but is not limited to, a rescue path from the rescue target to the hospital, a rescue path from the rescue target to the rescue center, a rescue path for transporting materials from the hospital to the rescue center, and the like.

In an optional embodiment, each target location is allocated one hospital or one rescue-center location, each rescue-center location matches one hospital in response to allocating each target location the one rescue-center location, and the step of determining the rescue plan for rescuing the one or more rescue targets based on the target locations, the hospital locations and the rescue-center locations includes the steps described below.

A rescue sub-path corresponding to each target location is determined. Multiple rescue paths are determined on the basis of the rescue sub-path corresponding to each target location, where the multiple rescue paths are used for rescuing the one or more rescue targets. A total rescue time required for each rescue path is determined. The shortest time among total rescue times is used as a target total time. The rescue path corresponding to the target total time is used as the rescue plan for rescuing the one or more rescue targets.

In this embodiment, the rescue sub-path refers to a rescue path corresponding to each target location. Each rescue path refers to a path for rescuing the one or more rescue targets. The total rescue time refers to a rescue time corresponding to each rescue path. The target total time refers to the shortest time among the total rescue times. In this embodiment, the rescue path corresponding to the shortest time among the total rescue times is used as the rescue plan for rescuing the one or more rescue targets.

In an optional embodiment, the step of determining the total rescue time required for each rescue path includes the steps described below.

Rescue sub-times required for rescue sub-paths corresponding to each rescue path is determined. Rescue sub-times are superimposed to obtain the total rescue time.

In this embodiment, the rescue sub-time refers to a rescue time required for the rescue sub-path. In this embodiment, the total rescue time is obtained through superposition of rescue sub-times corresponding to one or more rescue sub-paths in each rescue path.

With reference to FIG. 2, FIG. 2 is a schematic diagram illustrating the distribution of target locations, rescue-center locations and hospital locations according to Embodiment one of the present disclosure. It is seen from FIG. 2 that there are two rescue targets corresponding to target locations H1 and H2, two rescue-center locations R1 and R2, and two hospital locations P1 and P2. It is be seen from FIG. 2 that there are six rescue sub-paths for target location H1: the connection of H1, R1 and P1, the connection of H1, R1 and P2, the connection of H1, R2 and P1, the connection of H1, R2 and P2, the connection of H1 and P1, and the connection of H1 and P2. Similarly, target location H2 also corresponds to 6 rescue sub-paths. Then multiple rescue paths may be determined according to the rescue sub-paths corresponding to target locations H1 and H2. It is to be noted that computation is performed just once in response to different target locations having overlapped rescue sub-paths. For example, in response to rescuing both H1 and H2 through rescue-center location R1 and rescue-center location R1 acquiring materials from only P1, a total rescue time for rescuing H1 and H2=a time from H1 to R1+a time from H2 to R1+a time from R1 to P1. It is to be noted that in response to R1 having no rescue center, it is necessary to add a time for establishing a rescue center at R1 to the total rescue time. Exemplarily, if the shortest time corresponds to the case of rescuing both H1 and H2 through rescue center location R1 and rescue-center location R1 acquiring materials from only P1, then the connection from H1 to rescue-center location R1 and the connection from rescue-center R1 to hospital P1 are used as a rescue path for rescuing target location H1, and the connection from H2 to rescue-center location R1 and the connection from rescue-center R1 to hospital P1 are used as a rescue path for rescuing target location H2. That is, medical resources required by rescue targets corresponding to target locations H1 and H2 are uniformly transported from hospital H1 to R1, and the rescue targets corresponding to target locations H1 and H2 are transported to rescue center R1 for treatment.

Specifically, the total rescue time may be expressed by formula (1) described below.

$$f = {\sum }_{k} {f}_{1 κ} + {\sum }_{i} {\sum }_{k} {f}_{2 k , i} + {\sum }_{k} {\sum }_{j} {f}_{3 j , k} + {\sum }_{i} {\sum }_{j} {f}_{4 j , i} \\ i ∈ I , k ∈ K , j ∈ J \qquad ( 1 )$$

i∈I={1,2,K,iₘₐₓ} denotes a set of all hospital locations. k∈K={1, 2,K,kₘₐₓ} denotes a set of rescue-center locations. j∈J={1,2,K,jₘₐₓ} denotes a set of target locations. (f₁ₖ) denotes a time for establishing a rescue center. k(f_{2k,i}) denotes a time for transporting goods and materials from hospital i to the rescue center. j(f_{3j,k}) denotes a time from rescue center k to a target location. j(f_{4j,i}) denotes a time from hospital i to the target location.

Specifically, it takes time to establish the temporary rescue center, and the required time may vary in different study regions. The time for establishing the center may be obtained from formula (2).

f₁ₖ=P_{U}_{ₖ}·B_{W}_{ₖ},k∈K (2)

P_{U}_{ₖ} denotes a time for establishing a rescue center at location k, and B_{W}_{ₖ} denotes an index variable. If the rescue center is to be established at location k, B_{W}_{ₖ} is 1, and otherwise, B_{W}_{ₖ} is 0.

The time for transporting drugs and rescue devices from a hospital to the rescue center may be determined according to formula (3). For each hospital, the velocity for transporting goods and materials to the rescue center is related to regions.

$${f}_{2 k , i} = {B}_{{SM}_{k , i}} \cdot \frac{{D}_{k , i}}{{V}_{k , i}} , i ∈ I , k ∈ K \qquad ( 3 )$$

B_{SM}_{_{k,i}} denotes an index variable, where if goods or materials are transported from hospital i to location k, B_{SM}_{_{k,i}} is 1, and otherwise, B_{SM}_{_{k,i}} is 0.

$$\frac{{D}_{k , i}}{{V}_{k , i}}$$

denotes a ratio of a location distance D_{k,i} to an average velocity V_{k,i} from hospital i to a possible rescue center k, where V_{k,i} is determined by the materials transported from i to k.

The time from the rescue center to the target location may be determined according to formula (4).

αⱼ determines the urgency of each demand location. The greater the value of αⱼ, the more urgently the rescue target corresponding to target location j needs rescue.

$${f}_{3 j , k} = {α}_{j} {B}_{{SN}_{j , k}} \cdot \frac{{D}_{j , k}}{{V}_{j , k}} , k ∈ K , j ∈ J \qquad ( 4 )$$

The time from a hospital location to the target location may be determined according to formula (5).

$${f}_{4 j , i} = {α}_{j} {B}_{{S}_{j , i}} \cdot \frac{{D}_{j , i}}{{V}_{j , i}} , j ∈ J , i ∈ I \qquad ( 5 )$$

B_{SN}_{ⱼ}_{,k} (B_{S}_{_{j,i}}) is an index variable, where if location k (hospital i) provides rescue services for demand location j, B_{SN}_{_{j,k}} is 1, and otherwise, B_{SN}_{_{j,k}} is 0.

$$\frac{{D}_{j , k}}{{V}_{j , k}} ( \frac{{D}_{j , i}}{{V}_{j , i}} )$$

denotes a ratio of a distance D_{j,k} (D_{j,i}) to an average rescue velocity V_{j,k}(V_{j,i}) from rescue center k (hospital i) to demand location j.

Optionally, some parameters for determining the total rescue time may be limited for optimization. Specifically, formulas (6) and (7) restrict the material flow between the hospital and a possible rescue-center location: if there is no rescue center at location k, no hospital deploys materials. On the contrary, if the rescue center is to be established at location k, the rescue center receives materials from only one hospital, and each hospital may provide materials for several rescue centers.

$$\begin{matrix}{\sum }_{i} {B}_{{SM}_{k , i}} = {B}_{{W}_{k}} , i ∈ I , k ∈ K & ( 6 ) \\ {\sum }_{i} {B}_{S {M}_{k , i}} \geq 1 + ( {B}_{{W}_{k}} - 1 ) \cdot M , i ∈ I , k ∈ K & ( 7 )\end{matrix}$$

M denotes a great positive integer. Optionally, M is greater than or equal to 100.

Additionally, formula (8) introduces a rather obvious restriction: only when there is an established rescue center at location k, can rescue services be provided for nearby target locations. Additionally, each target location is rescued by one center or one hospital, which is restricted by formula (9).

$$\begin{matrix}{\sum }_{j} {B}_{{SN}_{j , k}} \leq {B}_{{W}_{k}} \cdot M , k ∈ K , j ∈ J & ( 8 ) \\ {\sum }_{j} {B}_{{S}_{j , i}} + {B}_{{SN}_{j , k}} = 1 , k ∈ K , j ∈ J & ( 9 )\end{matrix}$$

In view of the limited number of beds each hospital provides for rescue services for disaster victims, the number of victims sent to the hospital should be less than the maximum capacity of the hospital, as shown in formula (10). Formulas (11) and (12) give restrictions on index variable B_{SMN}_{_{i,j,k}}: if each victim at target location j can be sent to hospital i through rescue center k, B_{SMN}_{_{i,j,k}} is 1, and otherwise, B_{SMN}_{_{i,j,k}} is 0.

$$\begin{matrix}{\sum }_{k} {\sum }_{j} {P}_{{E}_{j}} {B}_{S M {N}_{i , j , k}} + {\sum }_{j} {P}_{{E}_{j}} {B}_{{S}_{j , i}} \leq {C}_{{A}_{i}} , k ∈ K , j ∈ J & ( 10 ) \\ {B}_{S M {N}_{i , j , k}} \leq \frac{{B}_{{SM}_{i , k}} + {B}_{{SN}_{k , j}}}{2} , i ∈ I , j ∈ J , k ∈ K & ( 11 ) \\ {B}_{S M {N}_{i , j , k}} \geq \frac{{B}_{{SM}_{i , k}} + {B}_{{SN}_{k , j}} - 1}{2} , i ∈ I , j ∈ J , k ∈ K & ( 12 )\end{matrix}$$

P_{E}_{ⱼ} denotes the number of victims at target location j, and C_{A}_{ᵢ} denotes the number of beds in hospital i.

Finally, as the rescue progresses, there may be more target locations. This means it is necessary to establish more temporary rescue centers. Established rescue centers should be considered in the planning of the distribution of new rescue centers since the established rescue centers are maintained and can be used for ongoing disaster relief work. This is expressed by the constraints in formula (13). According to the constraints of formulas (14) and (15), relationships between these rescue centers and hospitals and target locations are different from relationships between the new rescue centers and the hospitals and the target locations. Only when there are persons to be rescued in the rescue center, are goods and materials transported to the center.

$$\begin{matrix}{B}_{{W}_{k 1}} = 1 \leq {C}_{{A}_{i}} , {k}_{1} ∈ {K}_{1} & ( 13 ) \\ {\sum }_{i} {B}_{S {M}_{k , i}} \leq {\sum }_{j} {B}_{{SN}_{k , j}} \cdot M , i ∈ I , j ∈ J , k ∈ K & ( 14 ) \\ {\sum }_{i} {B}_{{SM}_{i , k}} \cdot M \geq {\sum }_{j} {B}_{{SN}_{k , j}} , i ∈ I , j ∈ J , k ∈ K & ( 15 )\end{matrix}$$

k₁∈K₁={1, 2,K kₗₘₐₓ} denotes locations where rescue centers has been established.

According to the technical solution of this embodiment of the present disclosure, target locations of one or more rescue targets are acquired and hospital locations of one or more hospitals are acquired, rescue-center locations of one or more rescue centers are determined based on the target locations and the hospital locations, and a rescue plan for rescuing the one or more rescue targets is determined based on the target locations, the hospital locations and the rescue-center locations. As such, the rescue plan for the rescue targets is automatically determined through the obtained location information, thus achieving the technical effect of automatically generating the rescue plan in a disaster event.

### Embodiment Two

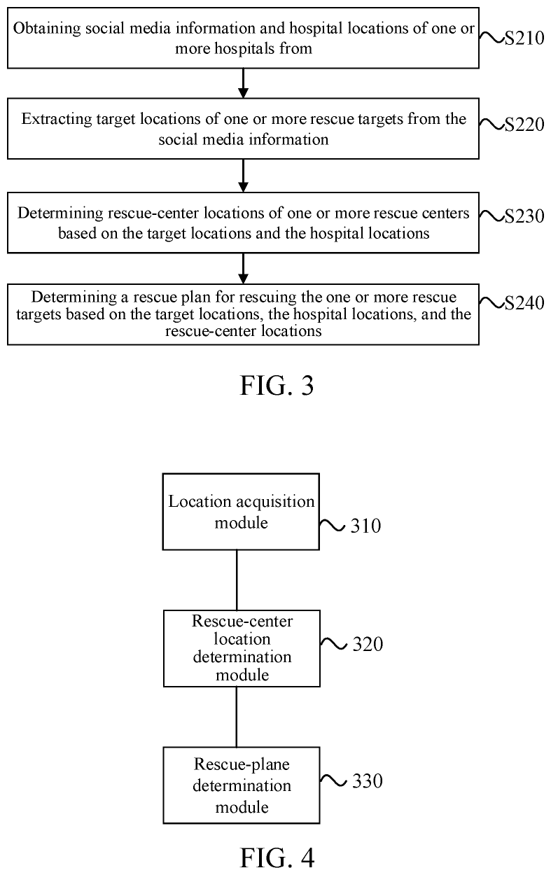

FIG. 3 is a flowchart of a method of determining a rescue plan according to Embodiment two of the present disclosure. This embodiment is a further refinement of the preceding technical solution. The method may be applied in a scenario of extracting target locations from social media information to make a rescue plan. The method may be executed by an apparatus for determining a rescue plan. The apparatus may be implemented in software and/or hardware, and may be integrated in a server.

As illustrated in FIG. 3, the method of determining a rescue plan according to Embodiment two of the present disclosure includes the following operations.

In S210, hospital locations of one or more hospital are acquired from the social media information.

The social media information refers to a message transmitted or posted through social media. The social media information includes, but is not limited to, a posted microblog, a transmitted WeChat message, an SOS distress message transmitted through a mobile phone, or the like, which is not specifically limited here. A hospital location refers to the location of a hospital. Optionally, the hospital location of the hospital may be extracted from a map or a database storing hospital locations.

In this embodiment, optionally, social media data may be acquired through a terminal of a rescue target. Additionally, during the handling of a disaster, the government posted much important information not only through traditional media, but also through new social media. The new social media includes a microblog, a video website and the like. Therefore, social media messages in this embodiment may be extracted messages indicating disasters and posted by various social media. For example, in hurricane Sandy in New York City, the government posted more than 2000 pieces of information and received more than 175000 follows through Twitter during the disaster. According to the preceding information, a disaster analysis and research framework based on social big data may be established.

In S220, target locations of one or more rescue targets are extracted from the social media information.

The rescue target refers to a target needing rescue. Optionally, in this embodiment, the rescue target refers to a person to be rescued. The target locations refer to locations of the one or more rescue targets. Specifically, each rescue target corresponds to a target location. In this step, the target locations of the one or more rescue targets are extracted through the social media information. According to the embodiment, the target locations can be quickly obtained in a disaster event if extracted from the social media information, so that the rescue time is greatly shortened and the rescue efficiency is improved. In an optional embodiment, the step of extracting the target locations of the one or more rescue targets from the social media information includes the steps described below.

Key information of each piece of the social media information is acquired, where the key information includes a keyword or keyphrase. It is determined, according to the key information, whether a target corresponding to the social media information is a rescue target. In response to the social media information corresponding to the rescue target, a target location carried in a target social media information is extracted to obtain the target locations of the one or more rescue targets, where the target social media information is the social media information corresponding to the rescue target.

In this embodiment, the key information refers to information that can determines whether the target is the rescue target. The keyword refers to a rescue-related word in the social media information, such as “water” or “medicine”. The phrase refers to a rescue-related phrase in the social media information, such as “clean water” or “mineral water”. The key information may be extracted from the social media information through a regular expression. Optionally, it may be determined whether the keyword or keyphrase in the key information matches a preset word. In response to the keyword or keyphrase matching the preset word, the target corresponding to the social media information is regarded as the rescue target. Extracting the target location carried in the target social media information may be extracting an address where the social media information is transmitted and using the address as the target location, or may be extracting location information carried in the social media information and using the location information as the target location, which is not limited here. Determination is performed on each piece of the social media information to obtain the target locations of the one or more rescue targets.

In S230, rescue-center locations of one or more rescue centers are determined based on the target locations and the hospital locations.

A rescue-center location refers to the location of a rescue center for rescuing the rescue target. It is to be noted that there may be an established rescue center at the rescue-center location, or may be no rescue center at the rescue-center location. In this step, the rescue-center location represents a piece of location information and does not represent whether there is the rescue center at the rescue-center location. The rescue-center location may be regarded as a hub connecting the hospital and the target location.

In S240, a rescue plan for rescuing the one or more rescue targets is determined based on the target locations, the hospital locations and the rescue-center locations.

The rescue plan refers to a plan for rescuing rescue targets. Optionally, the rescue plan includes, but is not limited to, a rescue route from the rescue target to the hospital, a rescue route from the rescue target to the rescue center, a rescue route for transporting materials from the hospital to the rescue center, and the like.

According to the technical solution of this embodiment of the present disclosure, target locations of one or more rescue targets are acquired and hospital locations of one or more hospitals are acquired, rescue-center locations of one or more rescue centers are determined based on the target locations and the hospital locations, and a rescue plan for rescuing the one or more rescue targets is determined based on the target locations, the hospital locations and the rescue-center locations. In this way, the rescue plan for the rescue targets is automatically determined through the acquired location information, thus achieving the technical effect of automatically generating the rescue plan in a disaster event.

### Embodiment Three

FIG. 4 is a schematic diagram of a rescue-plan determination apparatus according to Embodiment three of the present disclosure. The apparatus may be applied to a scenario of making a rescue plan for a rescue target in a disaster event. The apparatus may be implemented in software and/or hardware, and may be integrated in a server.

As illustrated in FIG. 4, the rescue-plan determination apparatus according to this embodiment may include a location acquisition module 310, a rescue-center location determination module 320 and a rescue-plan determination module 330.

The location acquisition module 310 is configured to obtain target locations of one or more rescue targets and hospital locations of one or more hospitals.

The rescue-center location determination module 320 is configured to determine rescue-center locations of one or more rescue centers based on the target locations and the hospital locations.

The rescue-plan determination module 330 is configured to determine a rescue plan for rescuing the one or more rescue targets based on the target locations, the hospital locations and the rescue-center locations.

Optionally, the location acquisition module 310 includes an information acquisition unit and a target location extraction unit.

The information acquisition unit is configured to acquire social media information.

The target location extraction unit is configured to extract the target locations of the one or more rescue targets from the social media information.

Optionally, the rescue-center location determination module 320 is specifically configured to perform computation on the target locations and the hospital locations through a PSO algorithm to determine the rescue-center locations of the one or more rescue centers.

Optionally, the PSO algorithm includes a GPSO algorithm, an LPSO algorithm, an MCPSO algorithm or a SIPSO algorithm.

Optionally, each target location is allocated one hospital or one rescue-center location, each rescue-center location matches one hospital in response to allocating each target location the one rescue-center location, and the rescue-plan determination module 330 includes a rescue sub-path determination unit, a rescue path determination unit, a rescue-total-time determination unit and a rescue-plan determination unit.

The rescue sub-path determination unit is configured to determine a rescue sub-path corresponding to each target location.

The rescue path determination unit is configured to determine multiple rescue paths based on the rescue sub-path corresponding to each target location, where the multiple rescue paths are used for rescuing the one or more rescue targets.

The rescue-total-time determination unit is configured to determine a total rescue time required for each rescue path.

The rescue-plan determination unit is configured to use the shortest time among total rescue times as a target total time, and use the rescue path corresponding to the target total time as the rescue plan for rescuing the one or more rescue targets.

Optionally, the rescue-total-time determination unit is specifically configured to determine rescue sub-times required for rescue sub-paths corresponding to each rescue path.

Rescue sub-times are superimposed to obtain the total rescue time.

Optionally, the target location acquisition unit is configured to extract key information in each piece of the social media information. The key information includes a keyword or keyphrase.

It is determined, according to the key information, whether a target corresponding to the social media information is a rescue target.

In response to the social media information corresponding to the rescue target, a target location carried in a target social media information is extracted to obtain the target locations of the one or more rescue targets. The target social media information is the social media information corresponding to the rescue target.

The rescue-plan determination apparatus provided in this embodiment of the present disclosure can execute the method of determining a rescue plan according to any embodiment of the present disclosure, and thus has functional modules and beneficial effects corresponding to the execution method. For an exhaustive description of this embodiment of the present disclosure, refer to the description of any method embodiment of the present disclosure.

### Embodiment Four

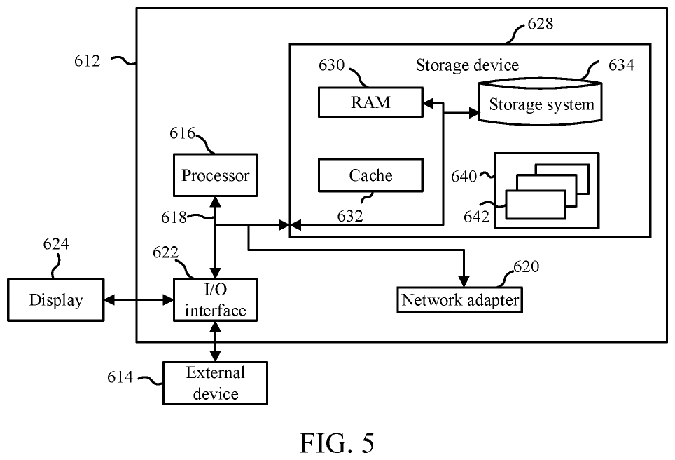

FIG. 5 is a schematic diagram of a server according to Embodiment four of the present disclosure. FIG. 5 is a block diagram of an exemplary server 612 for implementing the embodiments of the present disclosure. The server 612 illustrated in FIG. 5 is merely an example and is not intended to limit the function and scope of use of the embodiment of the present disclosure.

As illustrated in FIG. 5, the server 612 takes the form of a general server. Components of the server 612 may include, but are not limited to, one or more processors 616, a storage device 628, and a bus 618 connecting different system components (including the storage device 628 and the one or more processors 616).

The bus 618 represents one or more of several types of bus structures including a storage device bus or a storage device controller, a peripheral bus, a graphics acceleration port, a processor, or a local bus using any one of multiple bus structures. For example, these architectures include, but are not limited to, an industry subversive alliance (ISA) bus, a micro channel architecture (MAC) bus, an enhanced ISA bus, a video electronics standards association (VESA) local bus and a peripheral component interconnect (PCI) bus.

The server 612 typically includes multiple computer system readable media. These media may be any available medium that can be accessed by the server 612 and includes volatile and non-volatile media, and removable and non-removable media.

The storage device 628 may include a computer system readable medium in the form of a volatile memory, such as a random access memory (RAM) 630 and/or a cache memory 632. The terminal 612 may further include other removable/non-removable and volatile/non-volatile computer system storage media. Just for example, a storage system 634 may be configured to perform reading and writing on a non-removable and non-volatile magnetic medium (not shown in FIG. 5 and usually referred to as a “hard disk driver”). Although not shown in FIG. 5, it is feasible to provide not only a magnetic disk driver for performing reading and writing on a removable non-volatile magnetic disk (for example, a “floppy disk”), but also an optical disk driver for performing reading and writing on a removable non-volatile optical disk, such as a compact disc read-only memory (CD-ROM), a digital video disc-read only memory (DVD-ROM) or other optical media. In these cases, each driver may be connected to the bus 618 via one or more data media interfaces. The storage device 628 may include at least one program product having a group of program modules (for example, at least one program module). These program modules are configured to perform functions of various embodiments of the present disclosure.

A program/utility 640 having a group of program modules 642 (at least one program module 642) may be stored in the storage device 628 or the like. Such program modules 642 include, but are not limited to, an operating system, one or more application programs, other program modules and program data. Each or some combination of these examples may include implementation of a network environment. The program modules 642 generally perform functions and/or methods in embodiments of the present disclosure.

The server 612 may communicate with one or more external devices 614 (for example, a keyboard, a pointing terminal and a displayer 624). The server 612 may further communicate with one or more terminals that enable a user to interact with the server 612, and/or communicate with any terminal (for example, a network card or a modem) that enables the server 612 to communicate with one or more other computing terminals. These communications may be performed through an input/output (I/O) interface 622. Moreover, the server 612 may further communicate with one or more networks (such as a local area network (LAN), a wide area network (WAN) and/or a public network, for example, the Internet) through a network adapter 620. As shown in FIG. 5, the network adapter 620 communicates with other modules of the server 612 via the bus 618. It is to be understood that although not shown in FIG. 5, other hardware and/or software modules may be used in conjunction with the server 612. The other hardware and/or software modules included, but are not limited to, microcode, a terminal driver, a redundant processor, an external disk drive array, a redundant arrays of independent disks (RAID) system, a tape driver, a data backup storage system and the like.

The one or more processors 616 execute programs stored in storage device 628 to perform various functional applications and data processing, for example, to perform a method of determining a rescue plan provided in any embodiment of the present disclosure. The method may include the steps described below.

Target locations of one or more rescue targets are and hospital locations of one or more hospitals are obtained.

Rescue-center locations of one or more rescue centers are determined based on the target locations and the hospital locations.

A rescue plan for rescuing the one or more rescue targets is determined based on the target locations, the hospital locations and the rescue-center locations.

According to the technical solution of this embodiment of the present disclosure, target locations of one or more rescue targets and hospital locations of one or more hospitals are obtained, rescue-center locations of one or more rescue centers are determined based on the target locations and the hospital locations, and a rescue plan for rescuing the one or more rescue targets is determined based on the target locations, the hospital locations and the rescue-center locations. As such, the rescue plan for the rescue targets is automatically determined through the obtained location information, thus achieving the technical effect of automatically generating a rescue plan in response to a disaster event.

### Embodiment Five

An embodiment of the present disclosure further provides a computer-readable storage medium storing a computer program. When a processor executes the computer program, a method of determining a rescue plan provided in any embodiment of the present disclosure is performed. The method may include the steps described below.

Target locations of one or more rescue targets are acquired, and hospital locations of one or more hospitals are acquired.

Rescue-center locations of one or more rescue centers are determined based on the target locations and the hospital locations.

A rescue plan for rescuing the one or more rescue targets is determined based on the target locations, the hospital locations and the rescue-center locations.

The computer storage medium of this embodiment of the present disclosure may use any combination of one or more computer readable media. The computer-readable medium may be a computer-readable signal medium or a computer-readable storage medium. The computer-readable storage medium may be, but is not limited to, an electrical, magnetic, optical, electromagnetic, infrared or semiconductor system, apparatus or device, or any combination thereof. More specific examples of the computer-readable storage medium include (non-exhaustive list): an electrical connection having one or more wires, a portable computer magnetic disk, a hard disk, a random access memory (RAM), a read only memory (ROM), an erasable programmable read only memory (EPROM or flash memory), an optical fiber, a portable compact disk read only memory (CD-ROM), an optical memory device, a magnetic memory device, or any suitable combination thereof. In this document, the computer-readable storage medium may be any tangible medium containing or storing a program. The program may be used by or used in conjunction with an instruction execution system, apparatus or device.

The computer-readable signal medium may include a data signal propagated on a base band or as a part of a carrier wave. The data signal carries computer-readable program codes. Such propagated data signals may take multiple forms including, but are not limited to, electromagnetic signals, optical signals, or any suitable combination thereof. The computer-readable signal medium may further be any computer-readable medium other than a computer-readable storage medium. The computer-readable medium may send, propagate or transmit the program used by or used in conjunction with the instruction execution system, apparatus or device.

Program codes contained in the computer-readable medium may be transmitted via any suitable medium. The medium includes, but is not limited to, the wireless, a wire, an optical cable, the radio frequency (RF) or the like, or any suitable combination thereof.

Computer program codes for performing the operations of the present disclosure may be written in one or more programming languages or a combination thereof. The one or more programming languages include object-oriented programming languages such as Java, Smalltalk and C++, as well as conventional procedural programming languages such as “C” or similar programming languages. The program codes may be executed entirely or partially on a user computer, as a separate software package, partially on the user computer and partially on a remote computer, or entirely on the remote computer or terminal. In the case related to the remote computer, the remote computer may be connected to the user computer via any kind of network including a local area network (LAN) or a wide area network (WAN), or may be connected to an external computer (for example, via the Internet through an Internet service provider).

According to the technical solution of this embodiment of the present disclosure, target locations of one or more rescue targets are acquired and hospital locations of one or more hospitals are acquired, rescue-center locations of one or more rescue centers are determined based on the target locations and the hospital locations, and a rescue plan for rescuing the one or more rescue targets is determined based on the target locations, the hospital locations and the rescue-center locations. In this way, the rescue plan for the rescue targets is automatically determined through the acquired location information, thus achieving the technical effect of automatically generating the rescue plan in a disaster event.

It is to be noted that the above are merely preferred embodiments of the present disclosure and the technical principles used therein. It is to be understood by those skilled in the art that the present disclosure is not limited to the specific embodiments described herein. Those skilled in the art can make various apparent modifications, adaptations and substitutions without departing from the scope of the present disclosure. Therefore, while the present disclosure has been described in detail through the preceding embodiments, the present disclosure is not limited to the preceding embodiments and may include more other equivalent embodiments without departing from the concept of the present disclosure. The scope of the present disclosure is determined by the scope of the appended claims.

1. A method of determining a rescue plan, comprising:
obtaining target locations of one or more rescue targets and hospital locations of one or more hospitals;
determining rescue-center locations of one or more rescue centers based on the target locations and the hospital locations; and
determining a rescue plan for rescuing the one or more rescue targets based on the target locations, the hospital locations, and the rescue-center locations.

2. The method of claim 1, wherein obtaining the target locations of the one or more rescue targets comprises:
obtaining social media information; and
extracting the target locations of the one or more rescue targets from the social media information.

3. The method of claim 1, wherein determining the rescue-center locations of the one or more rescue centers based on the target locations and the hospital locations comprises:
performing computation on the target locations and the hospital locations using a PSO (Particle swarm optimization) algorithm to determine the rescue-center locations of the one or more rescue centers.

4. The method of claim 3, wherein the PSO algorithm comprises a GPSO (global particle swarm optimization algorithm), a LPSO (local particle swarm optimization algorithm), a MCPSO (multi-swarm collaborative particle swarm optimization algorithm), or a SIPSO (selective information particle swarm optimization algorithm).

5. The method of claim 1, wherein each of the target locations is allocated one of the one or more hospitals or one of the rescue-center locations, wherein when each of the target locations is allocated one of the rescue-center locations, and each of the rescue-center locations is matched with one of the one or more hospitals, the operation of determining the rescue plan for rescuing the one or more rescue targets based on the target locations, the hospital locations, and the rescue-center locations comprises:
determining a rescue sub-path corresponding to each of the target locations;
determining a plurality of rescue paths based on the rescue sub-path corresponding to each of the target locations, wherein the plurality of rescue paths are configured for rescuing all of the one or more rescue targets;
determining a total rescue time required for each of the plurality of rescue paths;
taking the shortest time among total rescue times as a target total time; and
using the rescue path corresponding to the target total time as the rescue plan for rescuing the one or more rescue targets.

6. The method of claim 5, wherein determining the total rescue time required for each of the plurality of rescue paths comprises:
determining rescue sub-times required for rescue sub-paths corresponding to each of the plurality of rescue paths; and
superimposing the rescue sub-times to obtain the total rescue time.

7. The method of claim 2, wherein extracting the target locations of the one or more rescue targets from the social media information comprises:
extracting key information in each piece of the social media information, the key information comprising a keyword or keyphrase;
determining whether a target corresponding to the social media information is a rescue target; and
in response to determining that the corresponding target of the social media information is a rescue target, extracting a target location carried in target social media information, to obtain the target locations of the one or more rescue targets, wherein the target social media information is the social media information corresponding to the rescue target.

8. An apparatus for determining a rescue plan, comprising:
a location acquisition module, configured to obtain target locations of one or more rescue targets and hospital locations of one or more hospitals;
a rescue-center location determination module, configured to determine rescue-center locations of one or more rescue centers based on the target locations and the hospital locations; and
a rescue-plan determination module, configured to determine a rescue plan for rescuing the one or more rescue targets based on the target locations, the hospital locations, and the rescue-center locations.

9. The apparatus of claim 8, wherein the location acquisition module comprises:
an information acquisition unit, configured to obtain social media information; and
a target location extraction unit, configured to extract the target locations of the one or more rescue targets from the social media information.

10. The apparatus of claim 8, wherein the rescue-center location determination module is configured to perform computation on the target locations and the hospital locations using a PSO (Particle swarm optimization) algorithm to determine the rescue-center locations of the one or more rescue centers.

11. The apparatus of claim 10, wherein PSO algorithm comprises a GPSO (global particle swarm optimization algorithm), a LPSO (local particle swarm optimization algorithm), a MCPSO (multi-swarm collaborative particle swarm optimization algorithm), or a SIPSO (selective information particle swarm optimization algorithm).

12. The apparatus of claim 8, wherein each of the target locations is allocated one of the one or more hospitals or one of the rescue-center locations, wherein when each of the target locations is allocated one of the rescue-center locations, and each of the rescue-center locations is matched with one of the one or more hospitals, the rescue-plan determination module comprises:
a rescue sub-path determination unit, configured to determine a rescue sub-path corresponding to each of the target locations;
a rescue path determination unit, configured to determine a plurality of rescue paths based on the rescue sub-path corresponding to each of the target locations, wherein the plurality of rescue paths are configured for rescuing all of the one or more rescue targets;
a rescue-total-time determination unit, configured to determine a total rescue time required for each of the plurality of rescue paths;
a rescue-plan determination unit, configured to take the shortest time among total rescue times as a target total time, and use the rescue path corresponding to the target total time as the rescue plan for rescuing the one or more rescue targets.

13. The apparatus of claim 12, wherein rescue-total-time determination unit is configured to determine rescue sub-times required for rescue sub-paths corresponding to each rescue path, and superimpose the rescue sub-times to obtain the total rescue time.

14. The apparatus of claim 9, wherein the target location acquisition unit is configured to:
extract key information in each piece of the social media information, the key information comprising a keyword or keyphrase; and
determine whether a target corresponding to the social media information is a rescue target; and
in response to determining that the corresponding target of the social media information is a rescue target, extract a target location carried in target social media information, to obtain the target locations of the one or more rescue targets, wherein the target social media information is the social media information corresponding to the rescue target.

15. A server, comprising:
one or more processors; and
a storage device, configured to store one or more programs,
wherein the one or more programs when executed by the one or more processors cause the one or more processors to perform the method of determining a rescue plan as recited in claim 1.

16. The server of claim 15, wherein the operation of obtaining the target locations of the one or more rescue targets comprises:
obtaining social media information; and
extracting the target locations of the one or more rescue targets from the social media information.

17. The server of claim 15, wherein the operation of determining the rescue-center locations of the one or more rescue centers based on the target locations and the hospital locations comprises:
performing computation on the target locations and the hospital locations using a PSO (Particle swarm optimization) algorithm to determine the rescue-center locations of the one or more rescue centers.

18. A computer-readable storage medium, storing a computer program, which when executed by a processor, causes the method of determining a rescue plan as recited in claim 1.

19. The computer-readable storage medium of claim 18, wherein the operation of obtaining the target locations of the one or more rescue targets comprises:
obtaining social media information; and
extracting the target locations of the one or more rescue targets from the social media information.

20. The computer-readable storage medium of claim 18, wherein the operation of determining the rescue-center locations of the one or more rescue centers based on the target locations and the hospital locations comprises:
performing computation on the target locations and the hospital locations using a PSO (Particle swarm optimization) algorithm to determine the rescue-center locations of the one or more rescue centers.
